(19) United States
(12) Patent Application Publication
(10) Pub. No.: US 2012/0290380 A1
(43) Pub. Date: Nov. 15, 2012

(54) REWARD TRAVEL MANAGEMENT SOFTWARE AND METHODS

(76) Inventors: Krista Paul, Denver, CO (US); Jon Nordmark, Highlands Ranch, CO (US)

(21) Appl. No.: 13/467,852

(22) Filed: May 9, 2012

Related U.S. Application Data
(60) Provisional application No. 61/518,621, filed on May 9, 2011.

(51) Int. Cl. G06Q 30/02

(52) U.S. Cl. 705/14.33

(57) ABSTRACT

There is disclosed a system, including a computer system, for managing travel points. In one embodiment, the system includes a single graphical user interface provided by a website, the single graphical user interface configured with a plurality of different rewards programs. The system includes a query tool configured to allow searching for award instance based on one of miles and points. The system includes a booking tool configured to facilitate online booking for at least one of regular fares and award redemptions. The system also includes software that determines relevant loyalty program bonus details, credit card offers, or program membership offers to feature in the search results. Other embodiments are also disclosed.

### REFERENCE TO PENDING PRIOR PATENT APPLICATION

This patent application claims the benefit under 35 U.S.C. 119 (e) of U.S. Provisional Patent Application No. 61/518,621, filed May 9, 2011 by Krista Paul, et al., for REWARD TRAVEL MANAGEMENT SOFTWARE AND METHODS. The above-identified patent application is hereby incorporated herein by reference.

### BACKGROUND

There are 180 million frequent flyers worldwide and 120 million in the United States alone. The online travel industry is the largest e-commerce category on the web with over $125 B in annual sales, and is projected to grow to $100 B in the next five years. The travel loyalty market is massive and growing, with 277,410,000 memberships in 2008. In fact, more than half of the adults who have traveled in the last 12 months belong to a loyalty program.

There are currently over 19 trillion unredeemed frequent flyer miles, which represent $400 billion U.S. dollars that are, for the most part, completely unmanaged by the holders. Frequent flyer miles are the single largest unmanaged asset class in existence. Despite the importance of this unique currency, frequent flyers find it extremely difficult to redeem miles. At the same time, airlines actually want consumers to stay involved in their loyalty programs and to find value in frequent flyer miles so that companies like Chase Bank will keep spending billions of dollars buying their miles. This is a huge opportunity to provide a service to this valuable segment of elite travelers (that account for 58% of all online travel bookings) and to make managing and redeeming frequent flyer miles as easy as booking a regular ticket online.

Several competitors have introduced different travel management components into some of their individual offerings. UsingMiles is the first site that has developed tools to help users effectively manage, monitor, and book award travel all in one place. UsingMiles is also responsible for being the first company to integrate loyalty bonus deals into travel search. This gives users the information they need at the point of purchase so they can make better decisions about selecting travel options that earn awards. Some of these competitors include GoMiles, MileTracker, Award Wallet, and Points.com (for mileage management) and Milewise, PointHub and Expert Flyer (for award search functionality).

The following sites have implemented one or more travel management components.

1. GoMiles (www.gomiles.com) tracks a variety of award programs and is free.

2. MilePort and MileTracker (www.mileport.com and www.miletracker.com) are downloadable desktop applications that track a variety of frequent flyer programs. There are no email notification systems and no ability to use the miles effectively.

3. AwardWallet (www.awardwallet.com), tracks a limited amount of information for about 300 programs. This site does not track other information such as expiring points, status, etc.

4. Points.com (www.points.com) also allows users to track balances in a variety of programs, and is powered by AwardWallet. This site allows users to proactively search for other ways to use their miles, with a primary focus on the consumer use of miles, such as trading them for Starbucks certificates, Blockbuster cards, and so on. This site provides a hotel booking feature to be used with points. This site does not provide any way to search for or book air travel using points and is more focused on the inactive traveler, not elite frequent flyers. Points.com has also developed a Global Points Exchange, which allows users to seek out other Points.com members who are interested in trading miles or points between reward programs. GPX brokers the exchange but the users are responsible for paying all of the fees associated with swapping points from airline to airline. The tool is still in its infancy and the fees make most trades cost prohibitive.

MileWise (www.milewise.com) is a free site that allows users to manage all of their frequent flyer miles in one place and search for award and paid travel. The mileage management component of the site is using AwardWallet technology.

PointHub (www.pointhub.com) is a another free site that allows users to manage all of their frequent flyer miles in one place and search for award and paid travel. Both of these sites launched similar technologies after UsingMiles launched their website.

Expert Flyer (www.expertflyer.com) is a subscription-based site that allows users to search for award and upgrade availability from a variety of airlines. Users can also set up alerts for when award tickets become available for specific flights. There is no capability to manage miles or book flights. The user must be familiar with travel agency codes. There is a real need in the marketplace for a site that can help solve problems for frequent flyers.

### SUMMARY

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

In an embodiment, there is provided a system, including a computer system, for managing travel points. In one embodiment, the system includes a single graphical user interface provided by a website, the single graphical user interface configured with a plurality of different rewards programs. The system includes a query tool configured to allow searching for award instance based on one of miles and points. The system includes a booking tool configured to facilitate online booking for at least one of regular fares and award redemptions.

Other embodiments are also disclosed.

Additional objects, advantages and novel features of the technology will be set forth in part in the description which follows, and in part will become more apparent to those skilled in the art upon examination of the following, or may be learned from practice of the technology.

### BRIEF DESCRIPTION OF THE DRAWINGS

Non-limiting and non-exhaustive embodiments of the present invention, including the preferred embodiment, are described with reference to the following figures. Illustrative embodiments of the invention are illustrated in the drawings, in which:

The invention and the following detailed description of certain embodiments thereof may be understood by reference to the following figures:

FIGS. 1-19 illustrate various embodiments of reward travel management software and methods.

### DETAILED DESCRIPTION

Embodiments are described more fully below in sufficient detail to enable those skilled in the art to practice the system and method. However, embodiments may be implemented in many different forms and should not be construed as being limited to the embodiments set forth herein. The following detailed description is, therefore, not to be taken in a limiting sense.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

The management software allows frequent flyers and loyalists to manage and utilize their points and helps them recognize the value of this often overlooked “second currency.” The novel management software helps users manage their loyalty portfolio, search for travel options, and connects them directly with supplier partners to book award travel or purchase paid flights.

The mileage management component of the novel management software eliminates the stress of managing multiple frequent flyer accounts from their individual sites. The novel management software makes it easy for users to aggregate all of their loyalty program information into one consolidated statement. In addition, users can set up notifications to receive alerts when miles or points are expiring, when enough miles/credits are available for free travel or rooms stays in their programs, or when elite status is achieved.

The management software facilitates the search for award fares and then tells users when enough miles or points are in their program to travel for free. Users can monitor a number of destinations and the novel travel management software serves up lowest published fares together with award travel options.

Lastly, the novel software facilitates online booking directly through deep linking with the supplier sites.

The management software helps frequent flyers successfully manage and utilize miles and points. The software makes it easy for users to aggregate and track hundreds of reward programs from one place, i.e., a Single Graphical User Interface (GUI) at a website, and may include different types of rewards programs, including airline, hotel, rental car, credit card programs, retail, restaurant, grocery and more. Users can search for, and monitor, specific award instances, including destinations for award fares/room stays and be notified when an award fare becomes available, and whether or not they have the miles/points to get it. The software may recommend when it is better to use cash vs. miles/points or when it is possible to use a combination of the two. The software may facilitate online booking for regular fares and award redemptions through deep linking directly into the supplier sites.

The novel management software comprehensively addresses the problems related to effectively managing multiple loyalty programs, redeeming miles/points for travel, and earning more miles/points when booking travel with cash.

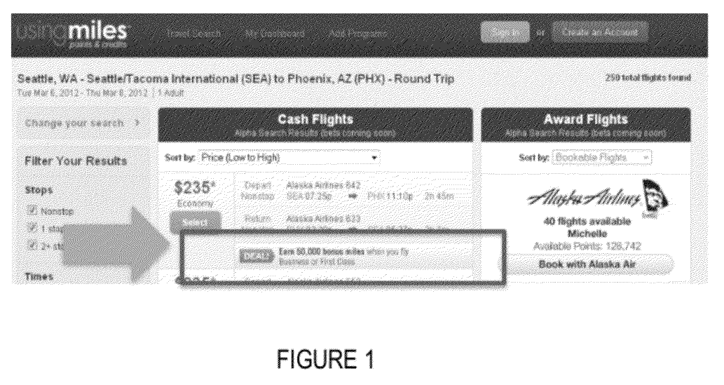

There is disclosed reward points/miles management software. In an embodiment, reward points/miles management software provides a platform for a user to search for an airline or hotel fare. Various embodiments of the reward points/miles management software utilize a combination of route data and personal information to determine relevant loyalty program bonus deals, credit card offers, or program membership offers to feature in the search results. The user gets personalized offers delivered right at the point of purchase, or when the need is most relevant/meaningful. Users benefit from being empowered with more information at the point or search so they can maximize their point or mileage accrual and/or take advantage of credit card and/or membership bonus offers. Credit card companies, supplier loyalty programs, etc., can capture new customers or co-branded card holders from non-members or non-captive cities or keep current members more engaged through relevant value-added offers right at the point of purchase. An exemplary embodiment is illustrated in FIG. 1.

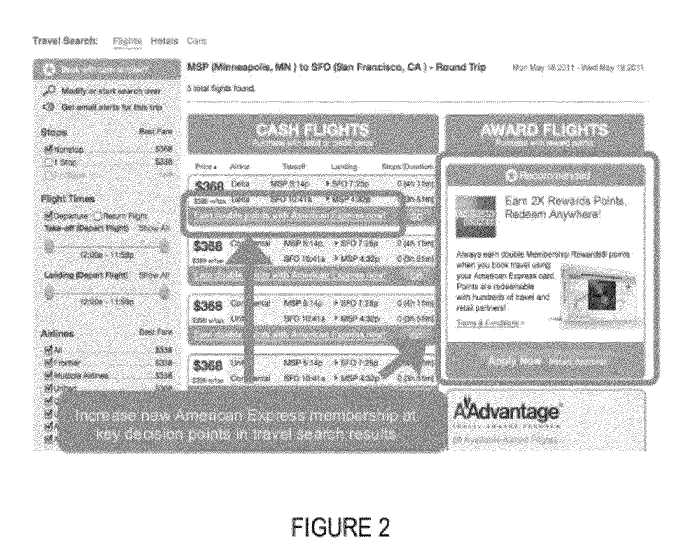

In an embodiment, and with reference to FIG. 2, UsingMiles also delivers relevant membership offers in the interstitial page to prompt new and relevant loyalty memberships.

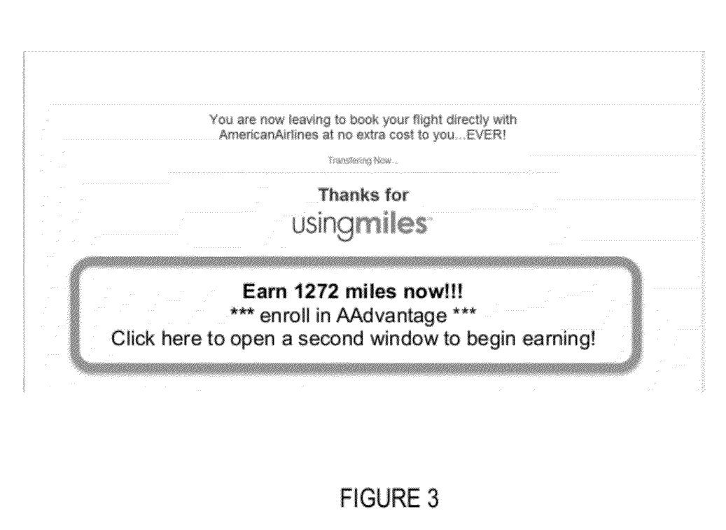

With reference to FIG. 3, and in an embodiment, a dialog box may be provided with a bonus offer to earn miles or other rewards based on a seamless search provided in conjunction with a flight search.

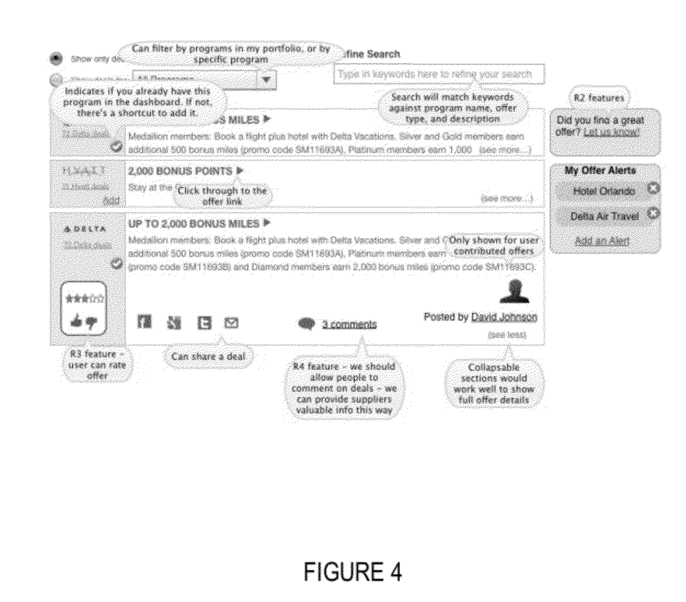

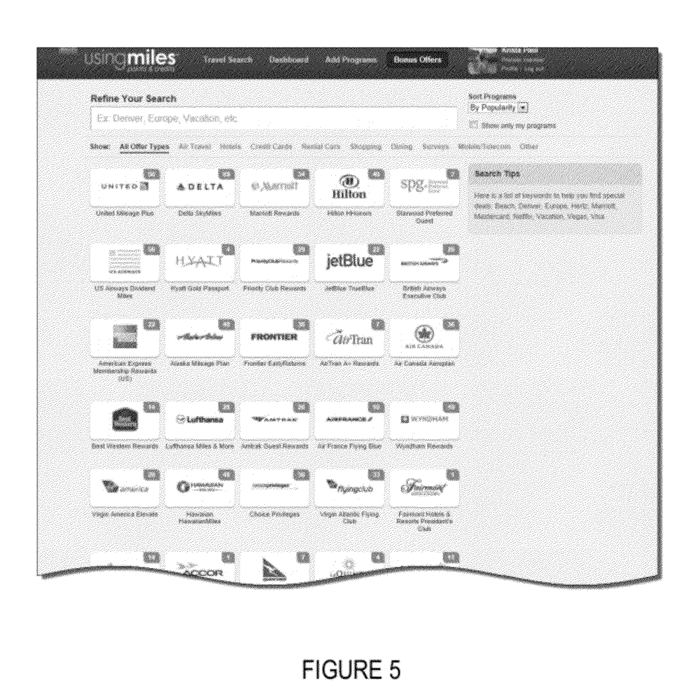

With reference to FIGS. 4 and 5, and in another embodiment, a search engine may be provided that incorporates thousands of bonus deals from multiple programs in one place. The framework may allow collection of bonus deals in a variety of ways, including through supplier/partner bonus deal feeds, manually through an admin managed by UsingMiles or other administrative staff, manual entry by partners through a partner admin, and user-contributed deals.

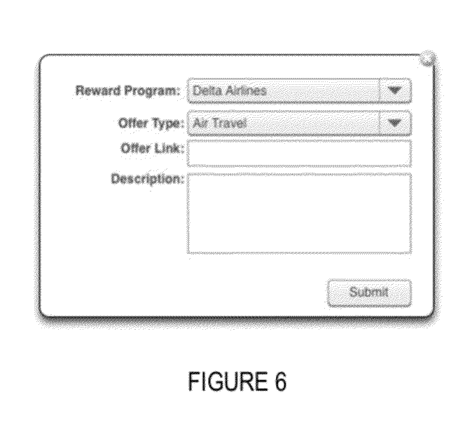

With reference to FIG. 6, and in an embodiment, users may be prompted to submit a bonus deal. The user may be asked to choose the program to which it applies and the type of deal it is. The user may provide a URL link to the deal. After the user has submitted the offer, it is saved with a pending-approval flag. An email will be sent to a specified email group notifying an administrator that a new deal is pending approval. The admin UI will be extended to let a user view unapproved bonus offers. The user can edit the offer, fill in missing details, and then approve, after which it will be publicly visible.

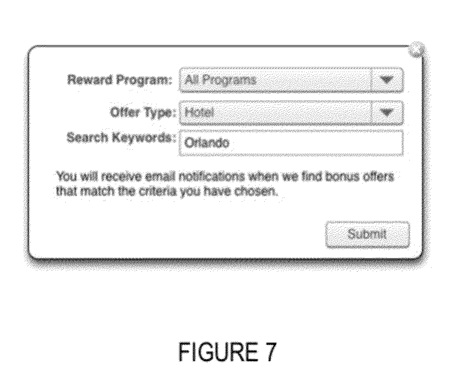

In another embodiment, and with reference to FIG. 7, users may set up alerts to receive bonus deals that match their chosen criteria. The user is allowed to specify the frequency of alerts.

Each bonus deal may include a thumbs up/thumbs down type of rating available for feedback. The rating will indicate how well received the offer is. The factors incorporated into the rating may include ratio of up/down rates, number of votes, and whether the deal is user submitted, UsingMiles (i.e., the host) submitted, supplier submitted, or received through a feed.

There is a UsingMiles Admin role for reward program suppliers/providers. This role will have authority to manage bonus offers. A new association will be defined to limit the reward programs for which the user can manage bonus offers.

To manually enter an offer the supplier will sign into the UsingMiles admin site and use the bonus offers user interface (UI.) The supplier will also be able to modify or remove other offers for their program that were user entered. However, if they remove offers received via a feed (InsideFlyer), then those offers may reappear the next time the feed is synced.

Users can comment on deals, share with friends in social networks, and filter the deals in a variety of ways to find the deals that best match their needs. Filtering options include free form text or keyword (Netflix, 1,000 bonus points, Austin, etc.), by programs in the current user's dashboard, by program type (Airline, Hotel, Restaurant, etc.), by program (United, Marriott), by program rank, popularity, date added, etc.

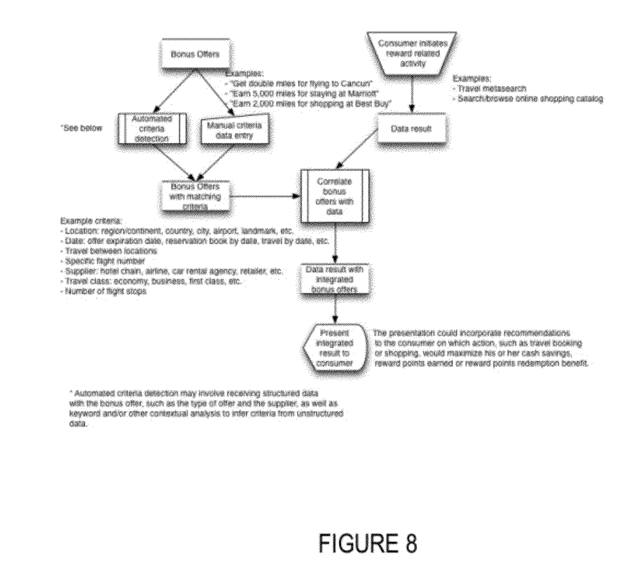

In another embodiment, and with reference to FIG. 8 providing an exemplary illustration of how bonus offers are integrated with information related to consumer activity such as travel metasearch, online shopping or dashboard activity, personalized user dashboards may be provided with relevant deals from their programs in order to make the loyalty dashboard more engaging, sticky and relevant. These deals will be automatically fed into the dashboards from the deal search engine based on the same criteria as filtering deals above (i.e., the filtering options described above.).

In another embodiment, reward points/miles management software provides a platform for user searches for an airline or hotel fare. A user is able to specify specific extended filters to base their results on, such as “Search to maximize miles” or “Search for airfares with WIFI.” The UsingMiles.com reward points/miles management software may display search results with the additional data points based on a combination of extended search filters, unique supplier value-adds and offerings, historical user activity/behavior, frequent flier portfolio information, etc. Examples include:

Extended Filters: “Maximize Mileage Accrual”.

Supplier offerings: WIFI, DirectTV, leg room, upgrades.

Historical user activity/behavior: price elasticity, booking class, luggage/carry on, etc.

Frequent flier portfolio info: programs they are members in, programs they should be members in, progress to elite status in programs, available upgrades, etc.

Using the reward points/miles management software, the user may be presented with a robust search result that identifies all of their customized opportunities to book travel and how each is associated with the user's personality, travel habits and supplier offerings.

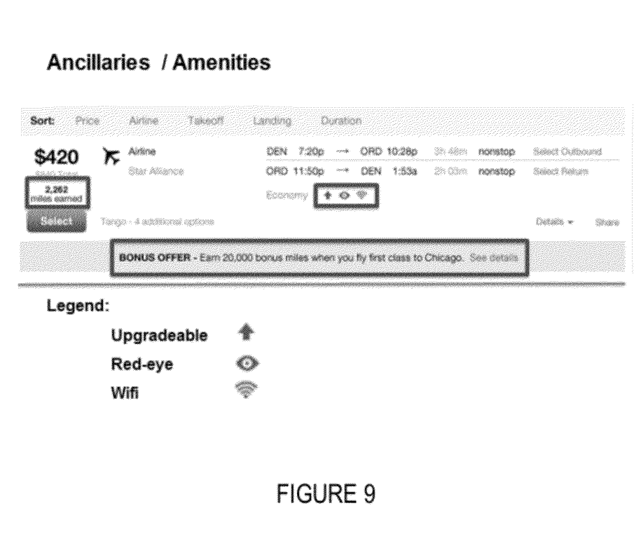

FIG. 9 illustrates an exemplary illustration of an embodiment in which the search platform breaks away from a commodity-driven price decision and moves into a value-based decision.

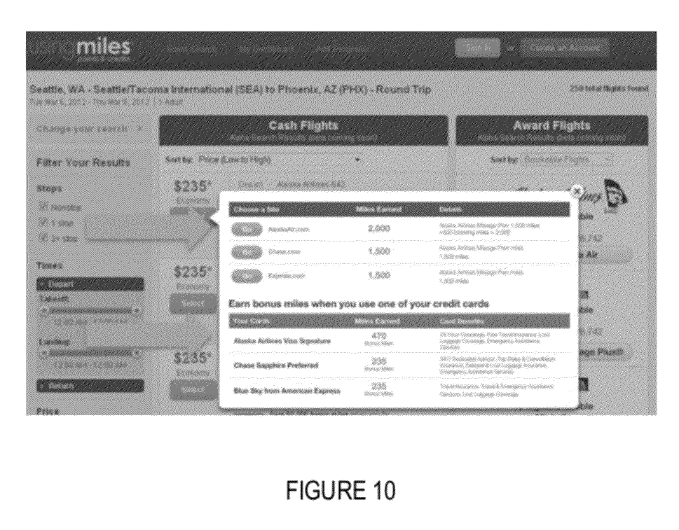

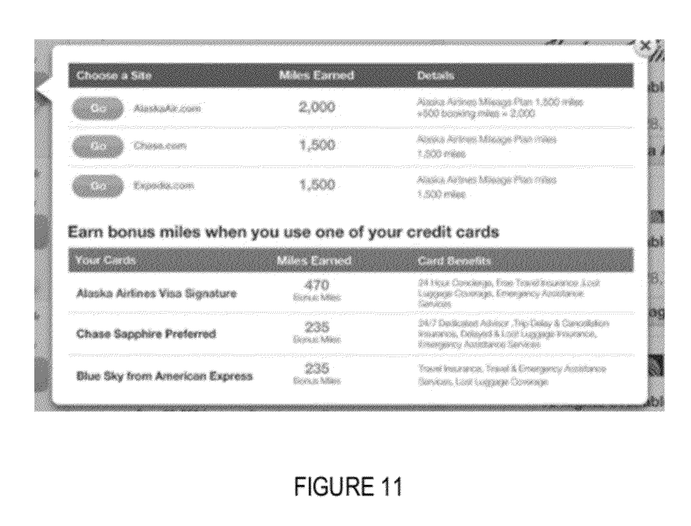

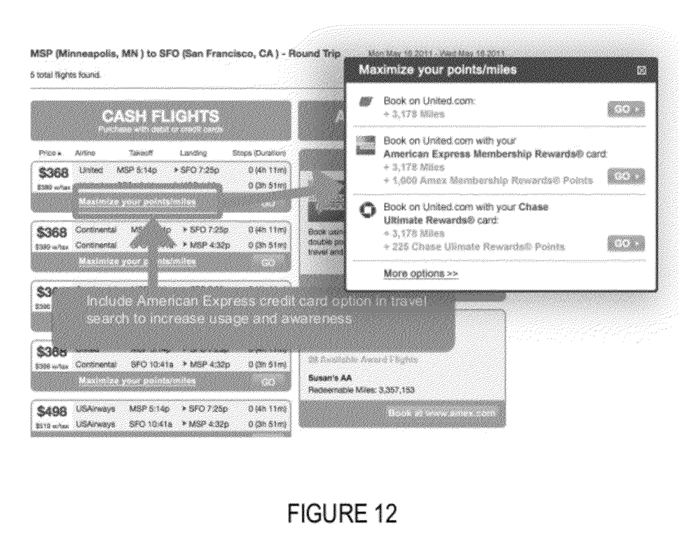

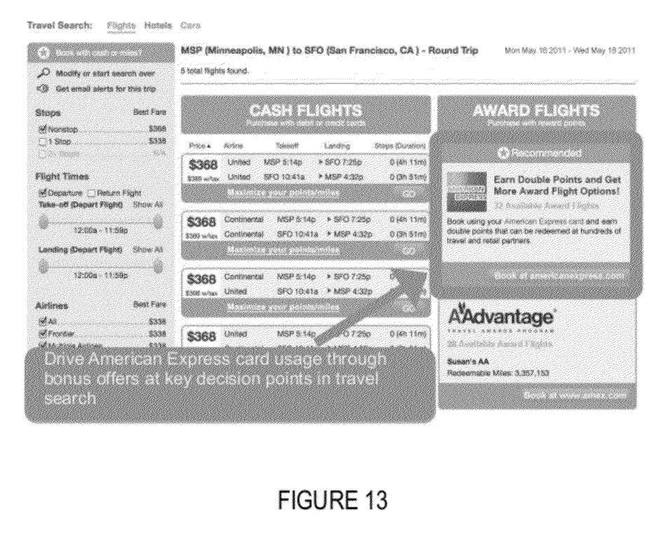

With reference to FIGS. 10-13, credit cards, Amtrak, and other travel players are presented in meta-search and the UsingMiles.com reward points/miles management software provides deep linking directly into their booking path to complete the purchase or redemption. Users are given clear information regarding the point/mile earning potential in each option.

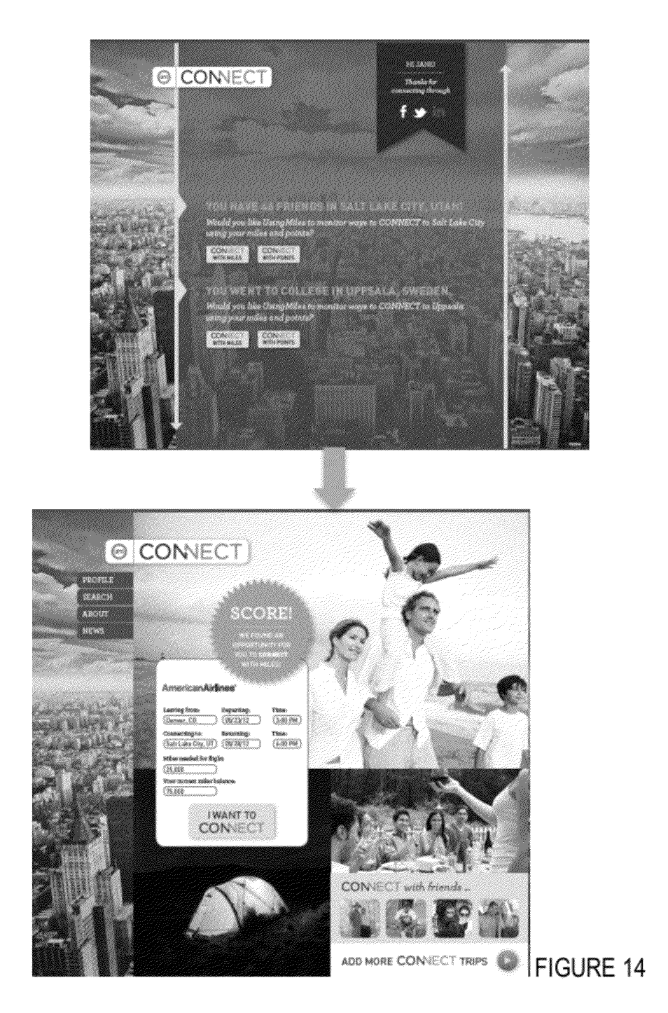

With reference to FIG. 14, and in another embodiment, the UsingMiles.com reward points/miles management software may provides relevant, value-driven offer that encourages members to book on the supplier site. The value-driven offers may be created using social profile data found in integrations with various social network partners including LinkedIn, Facebook, etc. For example, if a user joins UsingMiles through Facebook, UsingMiles can determine that you have a high number of friends from your hometown in Salt Lake City, Utah or your University College town in Uppsala, Sweden. UsingMiles can suggest that you monitor trips to these cities and deliver options when they become available.

This feature may also include a widget (for example, called “Connect”) that resides in the browser and notify users when such opportunities become available. This tool helps suppliers with inventory management and mile burn because the suppliers can offer award fares on less popular routes to people who have meaningful reasons to go to those places.

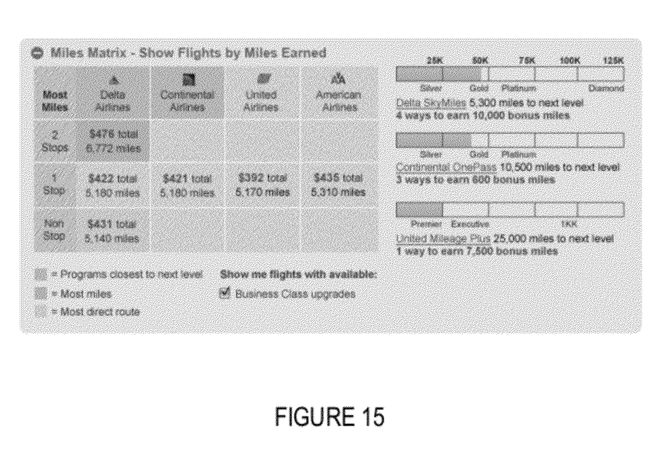

With reference now to FIG. 15, and in one embodiment, reward points/miles management software may provide a platform for user searches for a flight or hotel fare. The UsingMiles.com reward points/miles management software presents the “new matrix” above a set of search results and this revolutionizes how flights are sorted, displayed and selected. The exemplary illustration below demonstrates that user can obtain enough miles in Delta to reach elite status, even though they will have to pay more for that particular flight. Frequent fliers may be willing to pay more for a flight that gets them status but they aren't able to search in this way with current meta engines or OTA's. The new matrix delivers higher priced cash fares from cash/miles/status matrix driven searches. The new matrix results in a shift from cost-based to mile, status, and value-based decision-making. This matrix is also applied to search results for other reward points/miles management applications, including, but not limited to, hotels and credit cards.

In one embodiment, UsingMiles provides a “Secret Shopper” service to supplier partners whereby invitations are extended to UsingMiles users asking them to join a FAV Club, in which they agree to provide unbiased feedback of their experiences with a certain supplier in exchange for incentives (points, miles, etc.) The user is prompted to provide feedback each time they have a travel experience with a specific supplier. Positive messages are publicly pushed out to social networks to help improve supplier reputations. Negative feedback is routed directly to the supplier but not allowed in the public arena. The focus of the program is to help partners build long-term positive brand equity.

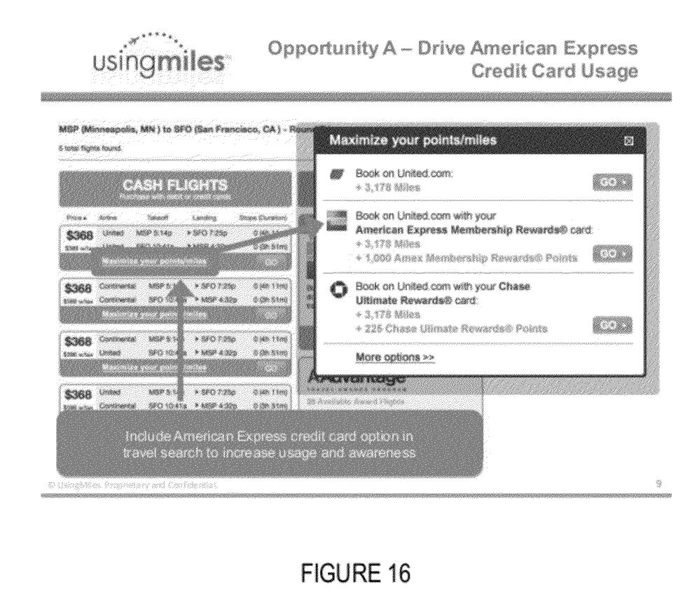

FIG. 16 illustrates an exemplary embodiment of reward points/miles management software provides deep linking directly into their booking path to complete the purchase or redemption.

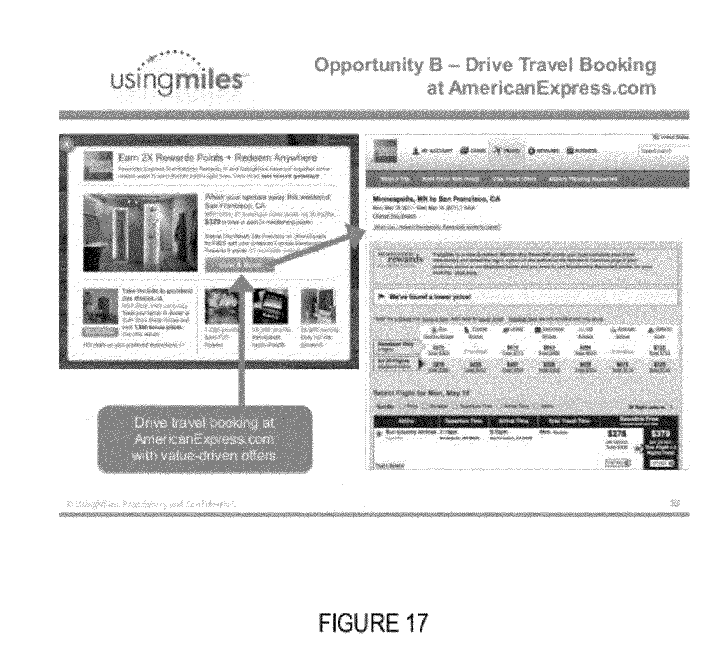

FIG. 17 illustrates another exemplary embodiment of the Connect widget discussed hereinabove.

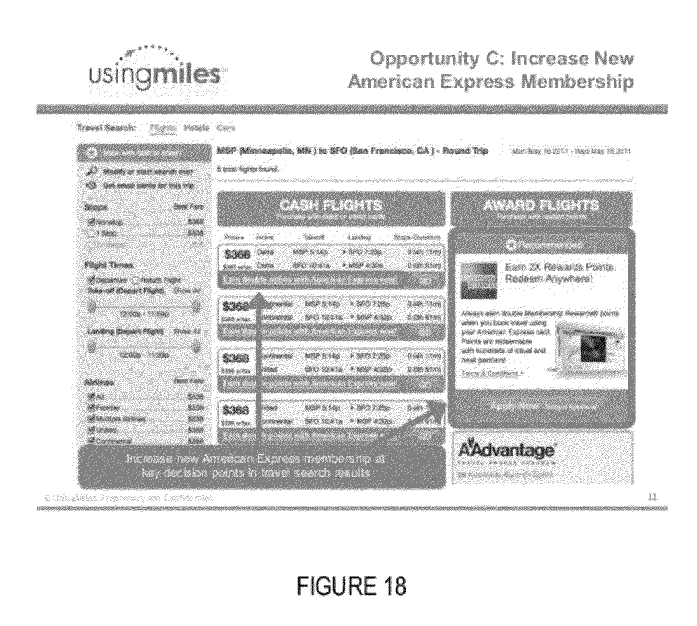

FIG. 18 illustrates another exemplary embodiment of reward points/miles management software that provides a platform for user searches for an airline or hotel fare. The UsingMiles.com reward points/miles management software recommends using a credit card's loyalty program. The UsingMiles.com reward points/miles management software deep links directly into the supplier.

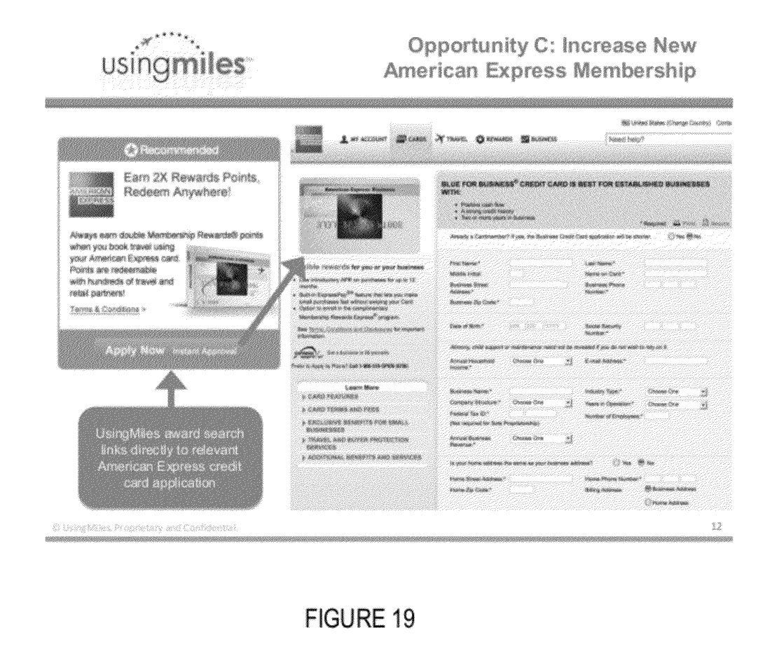

FIG. 19 illustrates an exemplary embodiment of software providing a recommendation for a rewards credit card. In addition, this software may provide a link to, or handle processing of, the relevant credit card application.

Although the above embodiments have been described in language that is specific to certain structures, elements, compositions, and methodological steps, it is to be understood that the technology defined in the appended claims is not necessarily limited to the specific structures, elements, compositions and/or steps described. Rather, the specific aspects and steps are described as forms of implementing the claimed technology. Since many embodiments of the technology can be practiced without departing from the spirit and scope of the invention, the invention resides in the claims hereinafter appended.

What is claimed is:

1. A system, including a computer system, for managing travel points, the system comprising:
a single graphical user interface provided by a website, the single graphical user interface configured with a plurality of different rewards programs;
a query tool configured to allow searching for award instance based on one of miles and points; and
a booking tool configured to facilitate online booking for at least one of regular fares and award redemptions.

2. The system of claim 1, wherein the award instance is an airfare.

3. The system of claim 1, wherein the award instance is a room stay.

4. The system of claim 1, wherein the query tool is configured to search based on miles already accrued by a user.

5. The system of claim 1, wherein the query tool is configured to search based on miles to be accrued by a user over a future time period.

6. The system of claim 1, wherein the query tool is configured to search based on points already accrued by a user.

7. The system of claim 1, wherein the query tool is configured to search based on points to be accrued by a user over a future time period.

8. The system of claim 1, wherein the booking tool is configured to use deep linking within an award provider website to facilitate online booking for at least one of regular fares and award redemptions.

9. The system of claim 1, wherein the query tool is configured to utilize a combination of route data and personal user information to determine search results.

10. The system of claim 1, wherein the search results include loyalty program offers.

11. The system of claim 10, wherein the offers are seamlessly embedded in a dialog box with the award instance determined by the query tool.

12. The system of claim 1, wherein the search results include credit card offers

13. The system of claim 12, wherein the offers are seamlessly embedded in a dialog box with the award instance determined by the query tool.

14. The system of claim 1, wherein the search results include program membership offers for feature in the search results.

15. The system of claim 15, wherein the offers are seamlessly embedded in a dialog box with the award instance determined by the query tool.
